(19) United States
(12) Patent Application Publication
(10) Pub. No.: US 2019/0121916 A1
(43) Pub. Date: Apr. 25, 2019

(54) SYSTEM AND METHOD FOR PLANNING AND OPTIMIZING SOCIAL MEDIA CAMPAIGNS

(71) Applicant: Storyblaster, Inc., Los Angeles, CA (US)

(72) Inventors: Paul Bennun, Los Angeles, CA (US); Neville Daniel, London (GB); Hillary Carlip, Los Angeles, CA (US); Maxine Lapiduss, Los Angeles, CA (US); Jessica Balke, Playa Del Rey, CA (US)

(21) Appl. No.: 16/167,423

(22) Filed: Oct. 22, 2018

Related U.S. Application Data
(60) Provisional application No. 62/575,934, filed on Oct. 23, 2017.

(51) Int. Cl. G06F 17/30; G06Q 50/00; G06Q 10/06

(52) U.S. Cl. CPC G06F 17/30893; G06F 17/30867; G06Q 10/06393; G06Q 50/01

(57) ABSTRACT

A server stores a plurality of social media campaign templates based upon prior successful campaigns. The server uses the templates to create social media campaigns based upon campaign duration, target fund raise, key performance indicator goal, and product category. A client computing device posts content on social media outlets and the server monitors the key performance indicators and determines a likelihood of reaching a campaign goal. If the server determines that the social media campaign is unlikely to reach a campaign goal, the server modifies the social media campaign.

### CROSS REFERENCE TO RELATED APPLICATIONS

This application claims priority to US Provisional Patent Application No. 62/575,934, “System And Method For Planning And Optimizing Social Media Campaigns” filed Oct. 23, 2017 which is hereby incorporated by reference in its entirety.

### BACKGROUND

Social media campaigns can be used to raise social awareness of products, projects, activities, organizations, etc. The planning and implementation of social media campaigns can be very complicated and requires the dissemination of posts on various social media channels as well as the timing and messages of each posting. The prior art permits a static categorization of social media posts for general intent. However, this is not, in itself, actionable data for the purposes of integration within a system. What is needed is an intelligent system for optimizing social media campaigns.

### SUMMARY OF THE INVENTION

In an embodiment, the present invention is a system and method that provides the programmatic creation of optimal social media campaign (“SMC”) strategy and tactics and real time qualitative analysis of SMCs in relation to a business key performance indicator (“KPI”) or goal, for an arbitrary number of business domains. Using a computer processor, salient generic features of successful SMCs are extracted by correlating social media activity with business KPIs; features are expressed in an algorithmic model for every business domain analyzed, which is stored in non-volatile computer memory.

A user's own computer's input devices are used to provide the operator's system with parameters specific to a user's SMC over a communications network, which permit the system to turn a generic model into a user-specific model, which the system presents as strategy and tactics for a future campaign in a human-readable, actionable form, displayed on the screen of the user's computing device via a communication network.

Relatedly, the system assesses metadata related to user's live SMC on public communication networks, which it uses as parameters to assess a user's SMC against an ideal model, and subsequently update strategy or tactics using the same hardware process as detailed above.

### BRIEF DESCRIPTION OF THE DRAWINGS

FIG. 1 illustrates a block diagram of a social media campaign system.

FIG. 2 illustrates an embodiment of a graphical user interface of a computing device illustrating a social media campaign over time.

FIG. 3 illustrates a Venn diagram illustrating the intent of social media postings.

FIG. 4 illustrates a graph of a key performance indicator v. number of social media posts for a sample of prior social media campaigns.

FIG. 5 illustrates a graph of social media activity and projected key performance indicator v. time.

FIG. 6 illustrates a graph of a projected key performance indicator v. time.

FIG. 7 illustrates a graph of a projected and real key performance indicators v. time.

FIG. 8 illustrates a graph of a projected and real key performance indicators and adjusted protected key performance indicators v. time.

FIG. 9 illustrates a graphical representation of the social media schedule.

FIG. 10 illustrates a user interface text, video, and image templates that can be used to create social media postings.

FIG. 11 illustrates a graphical representation of data processing in an SMC campaign resulting in a probability of success output.

FIG. 12 illustrates a flowchart of a social media campaign process.

FIG. 13 illustrates a diagram of a computer system which can be used with the social media campaign.

### DETAILED DESCRIPTION

There is widespread need for the use of social media to achieve business goals. Examples of business goals include: undertaking a crowd funding campaign, publicizing and marketing a new product release and a service business launch. A successful social media campaign can make the difference between success and failure of these overall business goals.

However, there is very little public understanding of the best strategy and tactics for conducting a social media campaign. This lack of understanding can lead to high levels of stress and uncertainty among consumers and within SMEs who need to undertake such a campaign. Existing service providers, who provide strategy and tactics with a high-touch, human-led approach, give a poor service and often use predatory pricing. Additionally, while the campaign and its associated business goal are very often the most important use of social media, the dynamics and optimal strategy of a campaign are not well known even within these existing service providers, who base their strategy on anecdote, not data. This is true for the initial state of a campaign, but true also in response to changing external circumstances during a campaign, where existing SPs may not alter their tactics, or not do so in an evidence-based manner, consistent with an optimal outcome.

There are currently no known systems that improve the experience of a social media campaign with a specific business goal, by providing the optimal strategy and tactics, and by providing tools and analytical data that support that specific business goal. The inventive system solves these problems by providing optimal, evidence-based, customized, strategy and tactics to its users. In the initial version of the product this strategy is provided in the form of a template. The solution simultaneously reduces stress and uncertainty, and improves the likelihood of a user meeting their business goal. During a campaign, the invention permits real-time analysis of a user's campaign and the optimization of strategy and tactics to reflect changing circumstances. Being undertaken algorithmically, this better product can be offered to users at a price well below that of the incumbent service providers.

The inventive system reduces dimensionality of the space of possible categorizations, relates social media posts to business key performance indicators (KPIs), and encompasses specific forms of intent related to desired change of audience behavior. The inventive system can provide usable strategies and tactics for using social media to achieve business goals across different domains. The system can output optimized social media strategies and tactics, as well as assess social media campaigns in real time. The inventive system can decrease the resource demand of its users and respond to changing environmental conditions and the actions of the users.

In an embodiment, the inventive system provides a programmatic discovery of optimal strategy and tactics for social media campaigns, which are statistically more likely to achieve an abstract business goal within a bounded range of time for a social media campaign. This process for providing a social media strategy can done through the analysis of previous, real-world social media campaigns to create an optimized social media model for each abstract business goal (e.g. crowd funding contributions, ticket sales, or first-day sales). The inventive system can then accept a user's social media campaign input parameters. The inventive system can analyze the inputs and output a customized social media strategy and tactics for a specific user's social media campaign. The optimized campaign may be expressed in the form of a social media template for the user. It may also be output in various forms, such as: displayed on a client computing device, displayed on a mobile computing device, displayed or printed as a text document, or other audiovisual forms.

For each abstract business goal, a significant number of ‘Social Campaign Anatomies’ (“SCA”) are created. Each SCA contains data for a specific business entity (e.g. a corporation or sole trader) across a date range of a social media campaign. The data consists of the relevant KPI for the business goal, together with all social media content published by the manager of the business KPI, and all resultant social media activity derived from that content. An SCA includes not just publicly available data, but adds a layer of novel analysis for each constituent post of that previous campaign: a system of classifying previously published posts by the author's intent of behavioral change in the consumer of that content.

The above is permitted by a new approach to semantic categorization and its subsequent algorithmic expression. Proprietary domain knowledge can be used to reduce the dimensionality of the space of potential categories, such that analysis can reveal usable insight. Analysis of the effect of ‘phatic’ social posts can be enabled. Phatic social posts can have the express intent of social interaction rather than direct business purposes. These categories are expressed in a form such that machine learning subsequently permits a computer system automatically categorize an indeterminate number of posts according to our definitions. The overall analysis is undertaken by seeking information from within the data that correlate with a successful outcome related to the business goal, and expressed in the model described above.

In addition to the creation of a model that can accept user parameters and output a custom strategy for a particular user and their business goal, the model can also be used to qualify a live, in-progress, social media campaign. As environmental changes occur that cause a user to deviate from optimal strategy such as a user's ad-hoc social media posts, or which otherwise affect the performance of a campaign against our model, the system can suggest alternative strategies and tactics that will have a positive outcome on the business KPI or overall success of the business goal.

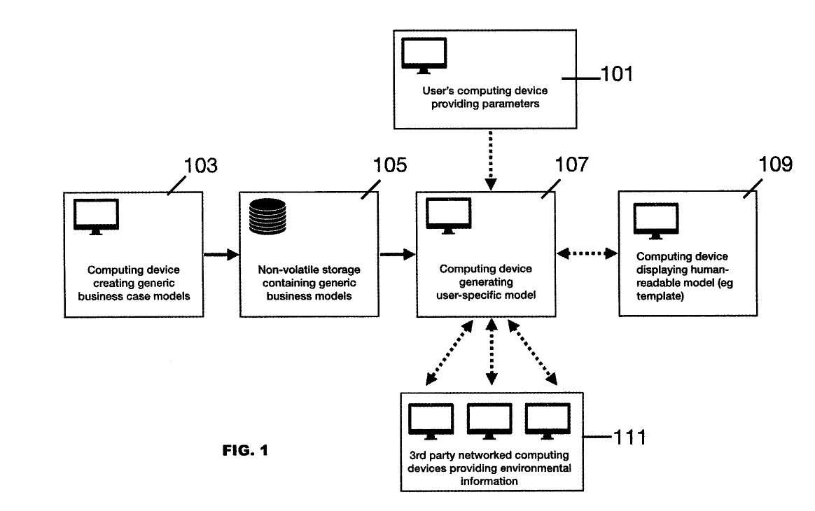

With reference to FIG. 1, in an embodiment the inventive system can include a system server 107 that communications with client computers 101 and other computing devices 103, a storage device 105 and 3rd party computing devices 111. A computing device 103 can be used to create generic business case social media models. This information can be stored on a non-volatile storage device 105 along with many other generic business models. A user using a client computer 101 can input campaign parameters including: product or service being promoted, the campaign start date and the campaign finish date. The system server 107 can receive the input campaign parameters from the client computer 101. The system server 107 can analyze the campaign parameters and generate a social media campaign model based upon the input campaign parameters. The system server 107 can transmit the social media campaign model to the client computer 109 which can be the client computer 101 used to input the parameters. The social media campaign can include instructions and guidance for conducting the social media campaign. The system server 107 can receive information from 3rd party computing devices 111 that can monitor social media activity. The system server 107 can monitor the social media activity of the user's social media campaign to determine compliance with the social media campaign model supplied by the system server 107. If there are compliance errors or if there are other environmental issues, the system server 107 can transmit information to the client computer 109 with instructions for correcting or improving the social media activities of the user.

Using a computing device 103, for each of an arbitrary number of different business domains, a generic model of the relationship between the social media activity of a business operating in that domain and a specific business KPI is created. The models are stored in non-volatile memory 105 by a system operator.

An end user, by means of their own computing device 101, transmits user-specific parameters describing their business case over a communications network to the system server 107. The user specific parameters may include a target date and or target goal for a KPI. The system server 107 additionally finds related information from 3rd party sources 111 of data connected to the same communications network, which define the environment in which the user exists.

The user specific parameter data can be applied by the system server to the generic model conforming to the user's business domain, and used to generate for each user a specific model describing the optimal set of actions, strategic and tactical, together comprising a social media campaign or “SMC.” The generated social media campaign data is then transmitted to the user's computing device, together with computer code and associated audiovisual content that enables it to be displayed and operated upon by a non-expert user. The user can undertake the generated social media campaign to achieve their goals.

Computer code on the system server periodically assesses the environment in which the user exists which can include the user's own actions using the generic model and initial SMC as comparators. The system server may transmit an alternative SMCs to a user's client computing device if server determines that changes to the prior SMC provide a higher probability of meeting the users' goals.

The inventive system can include processes for generating SMCs. In an embodiment, the inventive system can include various processes for generating SMC models. In an embodiment, the system can generate a generic model of actions for various business domains and then use the generic models to create social media campaigns for a specific set of user data. In order to generate the generic models, the system can identify and store actionable data from prior social media campaigns. The system can then determine or identify the actionable or data successful patterns from successful prior social media campaigns. In an embodiment, the system can also determine unsuccessful actions or patterns of actionable data from unsuccessful prior social media campaigns. Based upon the successful patterns of actionable data the system can creation of generic optimized models of social media actions for various business domains. The generic model can include a sequence of social media actions that are performed over the duration of the social media campaign.

The system server can extract actionable data from prior social media campaigns. The prior social media campaigns can include all social media campaigns successful and unsuccessful. The general subject matters (business domain) of the campaigns can be identified and the SMCs for each of these general subjects can be compared. From this information, distinctions in the SMCs can be determined and social media actions associated with successful SMCs can be determined. For each business domain, a number of different real-world business cases (“Social Campaign Anatomies” or “SCAs”) are assembled by and stored in a structured data format on non-volatile memory, each of which contains certain data for the business case over a defined period of time (i.e. Campaign).

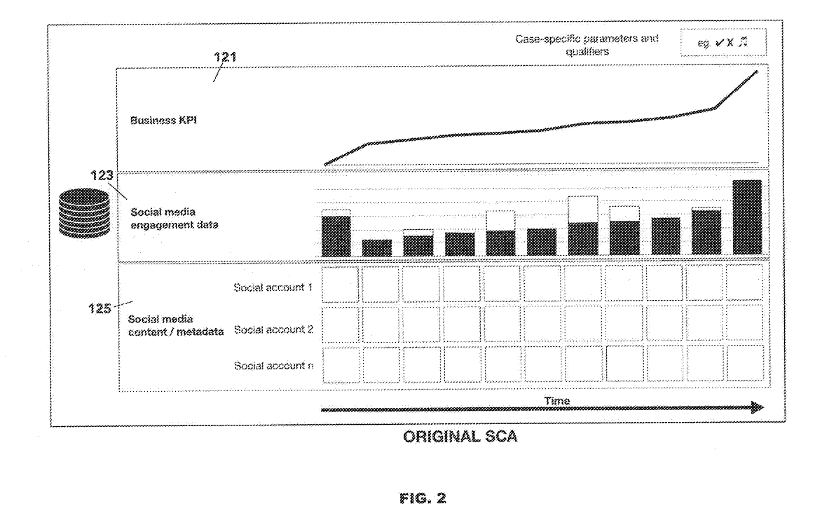

For example, with reference to FIG. 2, the information can be displayed in a graphical manner and may initially comprise: a business KPI section 121, social media content and metadata section 125 published by the KPI owner across any public social media platform, and a social media engagement data section 123 for each piece of content. The business KPI section 121 can be a line graph showing funding in the Y axis v. time in the X axis. In this example, the funding is increasing over time. The social media content and metadata section 125 can display the social media and metadata activity over time. In this example, the SMC can utilize a plurality of social media accounts and the activity in each of these accounts can be charted and graphically displayed over time. The system can also display feedback which is social media engagement data section 123 which can display various detectable consumer information such as duration of viewership numbers, viewing time, conversion to action rate, sharing of social media, forwarding of the social media postings to others, etc. Based upon this information, the system can determine which types and content of social media postings are effective, what are the most effective times for social media postings and what types of social media adjustments are most effective if less than expected engagement is detected. In an embodiment, the user interface can have a parameters and qualifiers for each business case button which can allow users to configure the information displayed on the graphical user interface (GUI).

While analysis of this data provides actionable quantitative data such as posting frequency can b e correlated with a successful SMC, no actionable qualitative data is provided. The inventive system provides a method of extracting the original intent of the content posted by the manager of the KPI in a form that permits automated analysis. For each business domain, the posts across every SCA are surveyed and a broad ‘Taxonomy of Intent’ (“ToI”) is created for that domain: a classification space of the various intents KPI managers had for posts in SCAs.

To analyze the data within each business domain via regression analysis to including the intent of an original post would be impractical at this point: quantitative and qualitative crossover between the members of the classification space can be too large to permit useful machine classification, and both the number of posts and functional crossover between the variables can be too large to permit manual classification. Additionally as a function of the number of SCAs which can be practicably assembled, the overall dimensionality of variables can be too large to produce useful correlations between the social media activity and the KPI. Table 1 is a list of some possible intents of posts.

TABLE 1

Educate the audience
Encourage Altruism
Transparency
Topical Awareness
Inclusivity
Create Advocacy
Seeding
Recognize Milestones
Leverage influencers
Establish Legitimacy
Direct Ask
Urgency/FOMO
Individual Opportunity
Upsell

The following is an example of unordered ‘Taxonomy of Intent’ for a business domain used for crowd funding. Domain expertise can be used to create of a simplified ToI by grouping elements of the classification space together into a smaller number of classifications with little functional cross-over, considering how the natural language, semantics, human behaviors, and economic behaviors are related to the specific domain, and operate on social media.

Every piece of social media content can also be assessed for classification as ‘phatic’ content, that is, content with the express intent of social interaction rather than direct business purposes. In an embodiment, a simplified ToI can be created by analysis of a predetermined number sample posts across all SCAs within a given domain. For example, in an embodiment, 3,000 posts can be analyzed. In an embodiment, the social media posts can initially be classified manually. These manual classification post patterns can then forming training data for subsequent machine classification of the social media posts. For example, after manual classification, the computer can identify post characteristics that are associated with each classification. A computer can then be used to undertake machine learning to create machine-usable definitions of the categories within a simplified ToI, and programmatic classification is then undertaken on the remainder of the social media posts across every SCA within a given domain. This computer analysis can form an additional layer of metadata stored on the same non-volatile memory as a given SCA. In an embodiment, the system can classify posts into one (or more) categories: 1. Establish campaign identity, 2. Build community, 3. Outreach, 4. Sell and possibly 5. Phatic.

The system server can receive and store the social media posts for the SMC. Software algorithms can be run on a computing device to review and sort the social media posts into at least one of the four or five post categories. The computing device can label the intents of the social media posts as metadata. In an embodiment of the invention, algorithms can be used to identify the intents of the posts. The algorithms can include:
1. Programmatic language rules filter out posts unrelated to the campaign (aka “phatic” posts), which are defined as a fifth intent category. Postings that are unrelated to the first four categories are placed in the phatic post category.
2. A programmatic sell classification algorithm identifies posts falling in the “sell” intent. This sell classification algorithm can analyze and identify sell posts through their words, grammar and sentence structure, posts associated with selling such as the position of URLs and the use of sell text including: buy, purchase, $, order, reserve, etc.
3. A programmatic outreach classification algorithm identifies posts falling in the “outreach” intent. This outreach classification algorithm can analyze and identify posts associated with selling through their words, grammar and sentence structure such as certain uses of the “@” symbol which can denote 3rd parties and the user of certain communicative words such as: tell, share, etc.
4. A programmatic classification algorithm identifies posts falling in the “Build Community” intent. This community classification algorithm can analyze words, grammar and sentence structure to identify posts associated with selling such as the use of the “@” symbol to denote 3rd parties and the use of inclusive words such as: we, us, etc.
5. Programmatic classification algorithm identifies posts falling in the “Establish campaign identity” intent. This campaign identity classification algorithm can analyze words, grammar and sentence structure to identify posts associated with establishing campaign identity such as certain uses of punctuation and capitalization; use of pronouns; words with a particular emotional sense.
6. A machine-learning random forest model with principal component analysis for dimensionality reduction can be used to determine the presence of a call to action of users regardless of the intent of the social media posts.

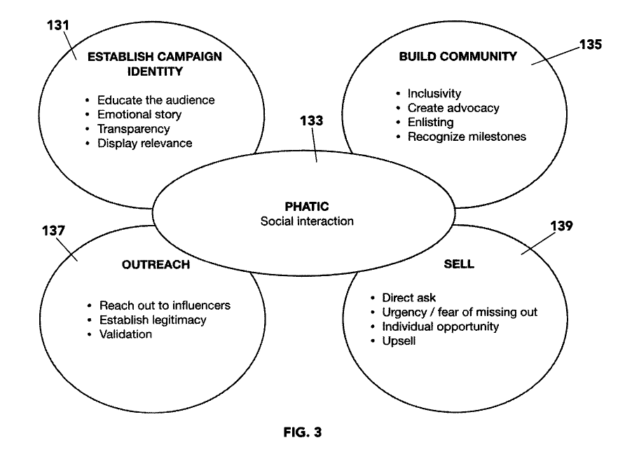

In an embodiment, with reference to FIG. 3, the inventive system can sort the posts phatic social interaction 133 into one (or more) of the following intents of social media postings: Establish Campaign Identity 131, Build Community 135, Outreach 137, and Sell 139. The inventive system can be used to create generic models of business domains. These generic models can include all the salient and actionable features with statistically significant social media actions that have a correlation to successful social media campaigns that reaches their funding goals. In an embodiment, the second process uses generic models. A model of the interaction of all available information with a given KPI is described in an algorithm that is stored in non-volatile memory connected to the server computer. Based upon the salient and actionable features, the computing device can construct the generic models. The salient and actionable features can include:
1. fundamental levels of social media activity, i.e. Facebook, Instagram, YouTube posts
2. relationship of individual business case parameters and qualifiers to KPI
3. relationship of posts of various intent to success and failure of KPI
4. discovery of underlying phases of successful social campaigns
5. discovery of other patterns of posting behavior which significantly increase KPI
6. the effect of environmental information such as public holidays, campaign launch day of the week, season, the effect of similar campaigns currently in progress etc.

As the invention focuses on business success, minimizing resource requirements of an eventual user is seen as a business benefit for each domain or category of the social media campaign. In an embodiment, the research model can seek the inflection point in the distribution of number of posts where the campaign reaches 100% of its funding goals. After reaching the funding goals, additional activity is not correlated with business success.

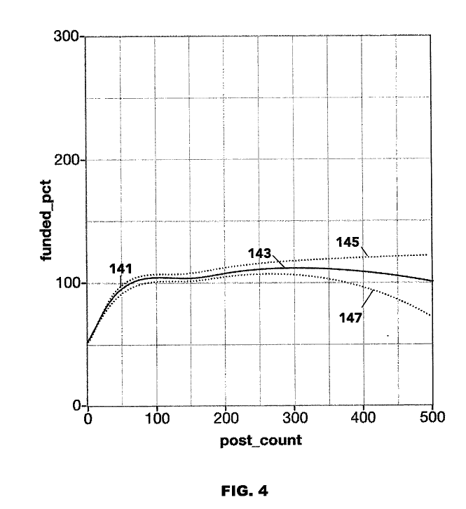

With reference to FIG. 4 an example graph of the funded percentage in the y-axis and number of social media posts in the x-axis. The graph lines show a center average line 143 as well as an upper dotted line 145 showing an upper range and a lower dotted line 147 showing a lower range of a social media campaign. In this example, an inflection point 141 for an average social media campaign may occur at ˜50 posts. More specifically, in the illustrated example on average social media campaigns with more than 50 posts are more likely to result in a successful 100%+ funding percentage and social media campaigns with fewer than 50 posts are more likely to result in an unsuccessful less than 100% funding percentage. Thus, for the graph domain, the 50 posts can be a baseline for a 100% funded campaign. For campaigns with more than 50 posts, there is higher illustrated likelihood that the campaign will exceed 100% funding. For example, in the illustrated example, at 300 posts the average funding can be about 110% funding. However, when the social media campaign reaches 500 posts, the likelihood of reaching the 100% funding percentage can be reduced to the point that half of the campaigns will be at or above 100% funding percentage and half of the campaigns will be below the 100% funding percentage.

The graph illustrated in FIG. 4 was created from a scatterplot of dots wherein each dot used to create the graph represents one or more social media campaigns. The dots positioned on or above the 100% funding level line are successful social media campaigns and the dots positioned below the 100% funding level line are unsuccessful social media campaigns. The scatterplot shows that most of the SMCs that failed had less than 50 social media posts. The failed campaigns are represented by the percentage of campaigns dots where the funded value on the y-axis is less than 100. There is a. higher concentration of successful campaigns above 50 posts. Overall, post count is positively correlated with campaign success, as shown by the best fit line, which has a. positive slope between x=0 through x=50 posts. However, once the campaigner posts over x>50 posts, the marginal benefit of adding additional posts drops off. For this reason, the best fit line becomes substantially horizontal as x>50 posts, because there is no relationship between number of posts and campaign success above 50 posts. While some campaigns with less than 50 posts are successful, and some campaigns with more than 50 posts still fail, campaigns with over 50 posts still have a higher likelihood of succeeding. There is no distinction between the types of posts in this particular plot.

### Relationship of Individual Business Parameters and Qualifiers to KPI

The generic model of a business domain can encompass a near totality of space of different business cases in order to accept user parameters and output the optimal strategy and tactics for social media campaigns. Therefore analysis must be undertaken to reveal the relationship between the global parameters and qualifiers of SCA and campaign success or KPI.

For example, in an embodiment, serving the crowd funding domain, the scale of the KPI in various business cases can differ greatly. Obtaining 100% of funding can vary by an order of magnitude across the totality of SCAs and there can be many different categories of products for social media campaigns. For example, the categories of campaigns can include: Art, Design, Games, Publishing, Comics, Fashion, Journalism, Crafts, Film & Video, Music, Theater, Dance, Food, Photography, and Technology. Each of these categories of campaigns can have a different generic social media campaign template. In an embodiment, the generic templates can be a plurality of graphs which each represent a histogram/density plot, where the y-axis can be the frequency/number of occurrences in the data and the x-axis is the funding goal of the campaign. The log of the funding goal is more useful for statistical purposes. The purpose of the graph is to show the spread of data within each category. For instance, tech campaigns tend to have higher goals than publishing campaigns. Each of the different categories can have different optimized template based upon the historic campaign data and as the server monitors additional campaign successes and failures, the generic SMC templates can be adjusted by the server.

### Relationship of Intent to Success and Failure of Business Case and to KPI

In an embodiment, the system server can perform an analysis on the categories of campaign data to find statistically significant usage of differing types of intent of the analyzed social media posts. The server can analyze the results of the intents of the posts in relation to both success and failure of the SMC. Several passes or analysis screenings can be performed by the server including simplifying predictors and subsequently performing further analysis.

### Discovery of Underlying Phases of Successful Social Campaigns

In an embodiment, the computer analysis can be durational/campaign-based, seeking clusters of behavior within ranges of dates to find the underlying common phases of successful campaigns and the activity associated with these successful campaigns. For example, seeking different ranges such as quarters or deciles where certain types activities are significantly associated with success or failure of the campaign and KPIs.

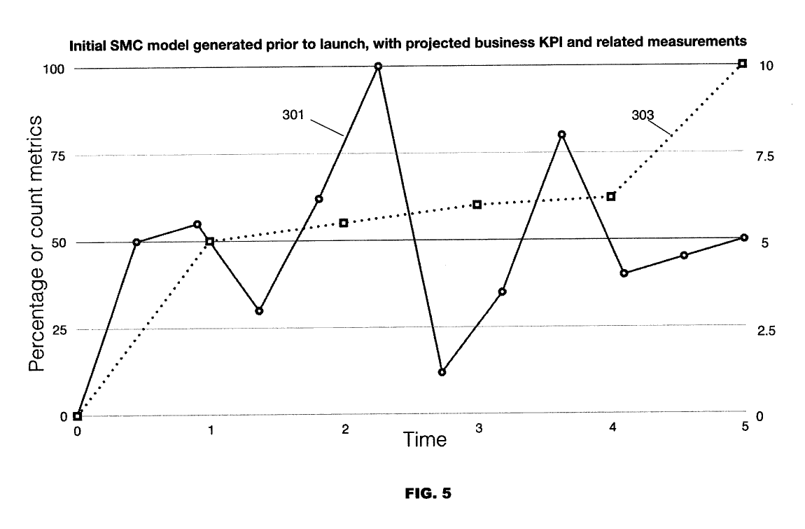

With reference to FIG. 5, an example of a model for an SMC is illustrated. The X-axis represents time and the Y-axis represents a percentage or count of metrics. For example, the solid line 301 can represent a social media posting plan v. time and the dotted line 303 can represent the KPI which can be funding percentage. In this example, the time is in weeks, the KPI scale is on the left from 0 to 100% and the social media posting plan scale is on the right from 0 to 10 postings. According to the SMC plan, the KPI which is funding should reach 100% after 5 weeks.

Discovery of Other Patterns of Posting Behavior which Significantly Increase KPI

Once the fundamental topography of a campaign is understood by the system server, analysis of overall patterns of behavior during the campaign, such as posting cadence can be determined by the system server. For example, several posts of one intent type can be followed by posts of another intent type are sought where patterns are associated with positive outcomes of prior social media campaigns known by the system server. Conversely, the system may also have historic SMC data of patterns were a sequence of intents can result in negative outcomes and the server can avoid producing SMCs that include these intent patterns.

In the initial embodiment, logistic regression analysis models, controlling for goal amount and category, are used by the system server to correlate the intent groups with global campaign success. Subsequently, stable and reproducible phases of generic campaigns can be determined by the system server by mapping out the intent data over a time series of the campaign. In order to normalize the different lengths of the different campaigns, the study campaign phases can be divided into quarters, sextiles, and later deciles, and running logistic regression analysis. Finally the time series can be divided into sextiles and deciles and general linear regression analysis can be performed.

In an embodiment, patterns of postings can be correlated by the system server with significant ‘spikes’ in funding are then sought by mapping a time series of the intents used in large campaign number studies. For example, 180 campaigns over a time series of funding contributions of the same 180 campaigns to reveal groups of use of specific intent that correlate positively and negatively with spikes in funding. The findings can be recorded on a file stored in structured data in non-volatile memory such that templates derived from them using the subsequent process will have a statistical quantitative advantage over SMCs that follow a random pattern of social media postings.

In an embodiment, a server can identify a funding spike which can be a KPI when the total donations on any given day (except the first and last seven days of a campaign) exceed the average daily donations of the campaign. Since 42% of donations are typically received in the first and last three days of a campaign, it is “unusual” for any given day in the middle of the campaign to exceed the average daily amount donated. Such an “unusual event” is considered a funding spike. Based upon funding studies of many SMCs, about 2-4 funding spikes per campaign are typical.

The generic model is expressed in code on the system server, such that arbitrary parameters for differing putative initial states may be input by the client computers to the server. A specific model SMC can be recorded in a file on the operator's system server which describe social media strategies and tactics with the highest correlation with a successful outcome from prior social media campaigns that have been analyzed by the system server.

For example, if a generic model for a given business domain shows a generic SMC with a duration of 30 days has the highest correlation with a successful campaign, and a putative start date of January 1 is entered by a client and the server will generate an SMC with January 31 as the suggested final day of the specific model SMC. Similarly, if the generic model shows that publishing exactly 3 pieces of content in the first three days of a campaign, each with a specific intent and this social media schedule has the highest correlation with a successful campaign past history, this social media schedule can be recorded in the SMC file which is forwarded to the client computing device. The system can store these successful generic models in a database coupled to a system server or other system computing device.

These generic models can be used with user input by the computing device to generation of user-specific SMCs with optimal strategy and tactics. The user-specific SMC with optimal strategy and tactics can be transmitted and displayed in a presentation of strategy and tactics in human-readable form, typically on a display of the client computing device.

### Generation of Optimal User-Specific Strategy and Tactics

From the operator's server, code is transmitted over a public communications network and is subsequently run on an end-user's client computing device. This code, which may be run inside a web browser or in the form of an application running directly on the user's client computing device, prompts the user to enter parameters and qualifying information related to an SMC they are running or wish to run such as a related business KPI or start or end date of their SMC.

This information is transmitted back from the user's client computer to the operator's server computer over the communications network and stored in memory connected to the operator's server computer. The user may enter all the necessary information themselves, or connect the operator's computer to a user's information stored in a structured data format in a memory device coupled to a 3rd party's computer. For example, a user with a Kickstarter or Indiegogo account may provide the operator's server computer with the URL of that account and the operator's computer may programmatically retrieve relevant parameters by means of the 3rd party's public or reverse engineered API, and store the information in memory attached to the operator's server computer. The operator's server computer may also programmatically seek environmental data from 3rd party computers via a computer network, which is also stored in memory attached to the operator's server computer.

Once sufficient information is stored on the operator's computer, it is then used as variable input to the system server which can process the data with an algorithm and associated generic template for the relevant business domain (as described above). For example, in an embodiment the resulting specific SMC can be stored in a file on the client computer in a structured data format such as XML. The model SMC can including day-by-day changes to the KPI, optimal social media strategy and optimal social media tactics. The strategy may contain but is not limited to: 1) an optimal length of SMC, 2) distinct phases of the SMC, 3) quantity, intent, platform and frequency of social media content, and 4) posts most amenable to paid support

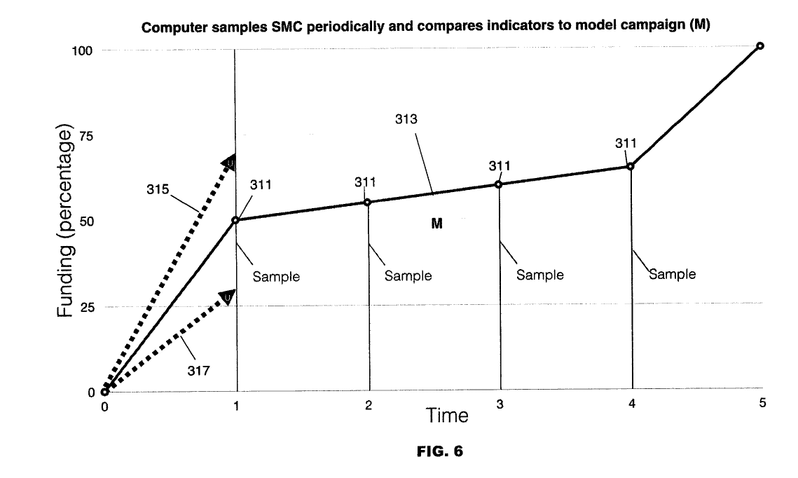

With reference to FIG. 6, following the initial calculation of optimal strategy and tactics, the client operator's computing device can sample 311 the PKI performance of a live campaign at intervals of an arbitrary or a predetermined periods of time such as each day or every few days. The SMC can include expected or target KPI results. The system can compare the expected KPI results to the actual KPI results at each sample 311 check to a target or expected KPI 313. For example, in some campaigns, the system may detected higher than target actual KPI results 315 can be above the target or expected KPI 313 and in other campaigns, the system may detected lower than target actual KPI results 317.

In some embodiments, the sampling of the performance can vary over the duration. A first sample rate may be 3 day checks and if the predicted results match the actual results, the system can continue to sample at the predetermined sample rate. However, if there are deviations between the predicted results and the actual results the system can made adjustments to the SMC and decrease the time between sample readings to determine the efficacy of the SMC changes. In other embodiments, the computing system can then assess the SMC in real time.

In an embodiment, the system can analyze the samples based upon probabilities. If the initial strategy and tactics remain those with the highest probability of meeting the campaign goals then the system can maintain the SMC schedule since the feedback is positive. If the probability of meeting the campaign goals drops below a predetermined value such as 85%, then the system can make adjustments to the SMC to attempt to improve the actual SMC performance to restore the probability of meeting the campaign goals by the end of the SMC. In an embodiment, the system can respond to lower than expected actual results by increasing number and or frequency of the social postings to increase consumer interest.

The computer divides a user's campaign into equal periods (3 days, in the initial embodiment of the invention). After the period has elapsed, the operator's computer by way of a public communications network queries various 3rd party computers and ascertains information related to the performance of the user's live SMC, including the performance of the business KPI and the public engagement created by the social media content. This data is compared to the specific model SMC. If the difference between the measurements and the predicted value in the specific model SMC is outside a specific threshold, the actual current values are passed to the algorithm, and a new specific model SMC is generated, replacing the file stored in memory attached to the operator's computer.

For every SMC, a set of inputs is input into a system model. A model that shows how that user's campaign should ideally perform based upon KPIs over the time duration of the campaign. Once the campaign has begun the inventive can use the real performance data records of a campaign, and compare the campaign model to the actual campaign data. Depending on the delta between our model and actual data, at various points, the system can choose to move the user on to a different campaign template that better fits the actual performance of their campaign, and which will maximize their KPI.

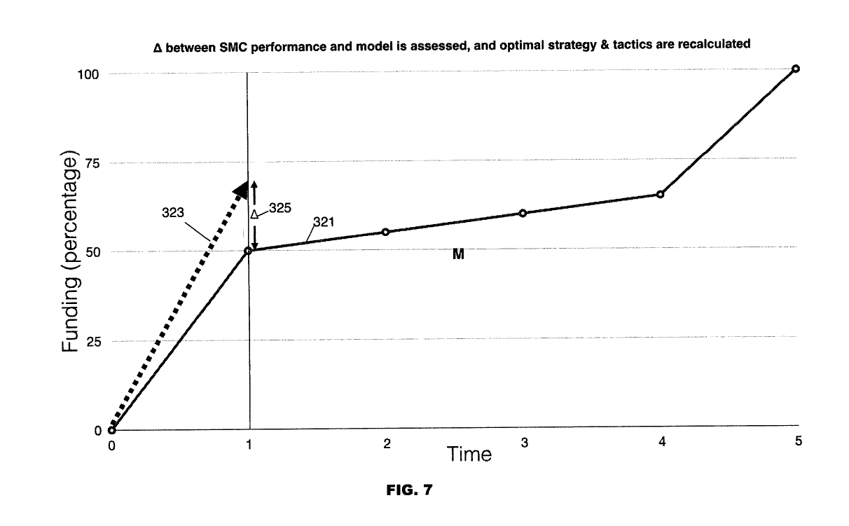

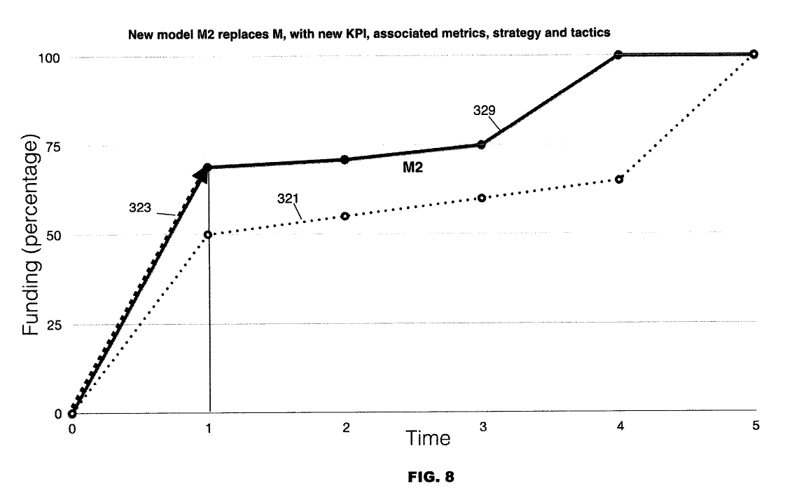

With reference to FIG. 7, an expected or target KPI for an SMC is illustrated as a solid line 321 and the actual detected KPI performance is a dotted line 323. At check point 311 which can be after week 1, the system determines a differential Δ 325 which is higher than predicted. The system can revise the predicted or target KPI based upon the actual PKI measurements. With reference to FIG. 8, based upon this deviation, the system can recalculate a predicted or target KPI 329. In this example, the system has updated the time at which the funding KPI reaches 100% to 4 weeks from the initial prediction of 5 weeks.

### Presentation of Strategy and Tactics in Human-Readable Form

The specific model SMC stored on the operator's computer is transmitted over a public communications network where it is interpreted by computer code running on the user's computing device. The interpreting code may be transmitted from the operator's server or from a 3rd party provider of software (such as Apple's App Store) over a public communications network, and may run inside an internet browser or has a native application.

On being passed the strategy and tactics for a campaign, a rendering component provides them to the user in an usable form. The rendering component may further have publishing capabilities such that it can publish any constituent post of the strategy directly to social media at the optimal time as suggested by the invention or as amended by the user.

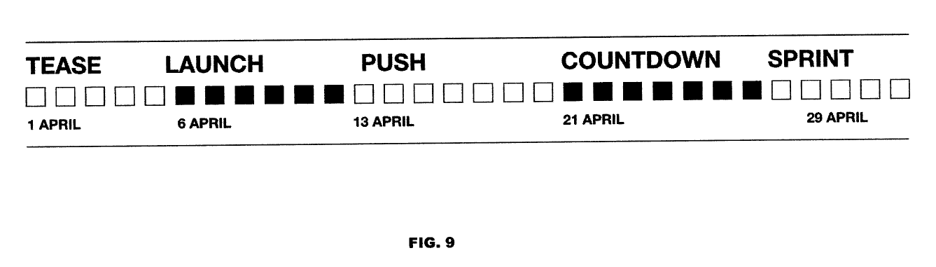

In an embodiment, a visual representation of campaign strategy phases named in vernacular language and other important data about the campaign strategy such as dates and duration of phases. With reference to FIG. 9, a graphical representation of the social media schedule is illustrated. The social media schedule can include five sections. In this example, the five sections are: Tease which can be days prior to offering the product for sale, Launch the initial sales days, The Push were the goal is to maintain KPI momentum, Countdown which are the days leading up to the end of the campaign, and Final Sprint which are the last days just prior to the end of the campaign. In this example, the squares can graphically represent the time associated with each section of the SMC. In this example, there are 5 days in the Tease, 7 days in the Launch, 8 days in The Push, 8 days in the Countdown and 5 days in the Final Sprint. In other social media schedules, there can be different numbers of days for the different sections of the SMC.

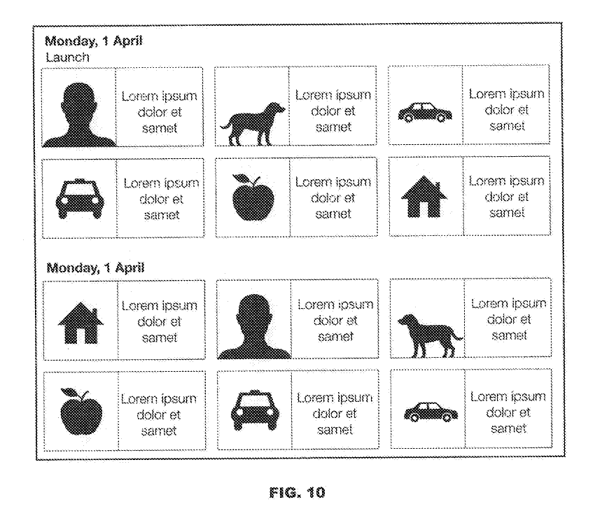

In an embodiment, a template containing an exemplar for every tactical post in a campaign which may be further customized for a user's specific circumstances either by the user themselves or by integration with 3rd party sources of information related to the user's campaign (such as a Kickstarter or Indiegogo campaign, in the case of the initial embodiment of the invention). With reference FIG. 10, the inventive system can have a user interface which can display text, video, and image templates that can be used to create social media postings. The posting channels can include various types of social media including: Pinterest, Facebook, Twitter, etc. The content of the social media posting can include images, video, and text is the way the intent of the post is communicated. Template posts demonstrating the desired intent of a particular post are created, and the user customizes the content with their own details, or in possible embodiments, permits the system to customize the posts, using data supplied to or obtained by the system, such as URLs or names.

The server can provide a text of the SMC strategy in natural language. The server can also provide programmatically produced messages, alerts or reminders to the user's client computer. The rendering component may further have publishing capabilities such that tactical posts which can be stored in a post database. The system can automatically publish the stored posts to social media at the optimal time as suggested by the SMC or as amended by the user.

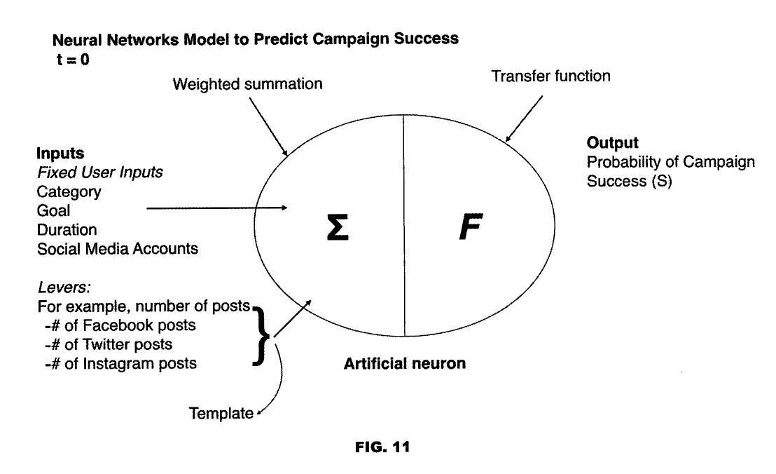

With reference to FIG. 11, a graphical representation of an embodiment of the SMC campaign data processing performed by a computing device in order to provide a campaign success prediction. The inputs can include fixed and lever inputs. The fixed user inputs can include: category, goal, duration and social media accounts. The lever inputs can include numbers of posts such as number of Facebook posts, number of twitter posts, number of Instagram posts, number of Pinterest posts, number of other social media posts. Based upon the inputs, the server can use a stock or model social media algorithm that can be used to create a social media schedule for the campaign. The algorithm can provide a weighted summation for each of the inputs and apply the weighted summations with a transfer function that can predict the probability of campaign success at the beginning of a campaign. When the campaign starts, the system can monitor the campaign results including: quantity and quality of the social media posts, identify the intents of the social media posts and continue to predict the likelihood of success throughout the social media campaign.

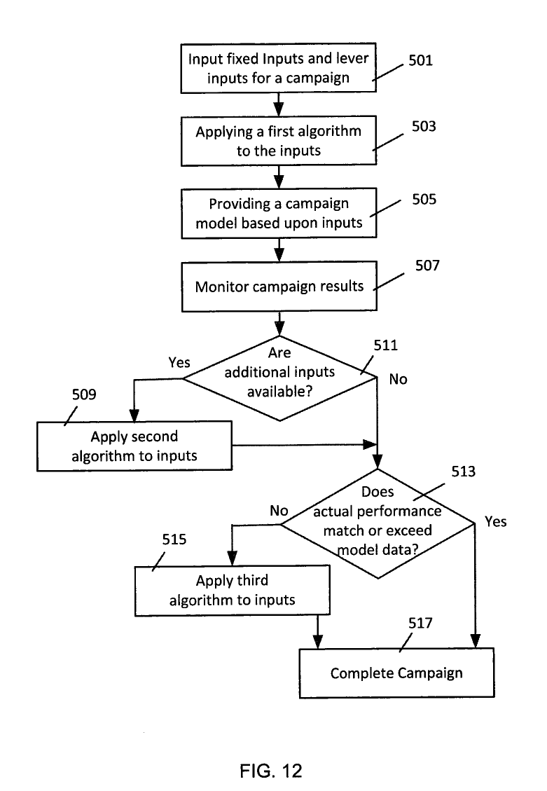

In an embodiment with reference to FIG. 12, a flowchart of a social media method is illustrated. The system can start by a user inputting campaign information including: fixed inputs and lever inputs through a user interface of a client computer 501. The input campaign information is transmitted to a system server. The input information can be compared to a plurality of social media models. The server can select the social media model that most closely matches the input campaign information. The algorithm associated with the most closely matched social media can be applied to the input campaign information 503. Using the input campaign information, the server can providing a campaign model 505. The user can receive the campaign model and proceed with providing the social media postings in accordance with the campaign model. The server or connected computer(s) can monitor the social media activities 507.

During the campaign, the server may determine that additional input information is available 511. If additional input information is available a second algorithm can be applied to the cumulative input information 509. A revised social media campaign plan can be transmitted to the client computer and social media postings can be published based upon the revised social media campaign. The server can monitor the social media activities posted in response to the revised social media campaign. If additional information is not available, the server can continue to use the first algorithm and the social media campaign can proceed based upon the original social media schedule.

The server can determine if the actual performance of the social media campaign matches or exceeds the social media model data 513. This information can also be used by the server to predict the likelihood of success meeting the campaign goals. If the system predicts that the goals are not going meet the goal, the server can apply a third algorithm to the social media inputs 515. The third algorithm output can be configured to result better results so that the social media campaign will reach its goals and the campaign can be completed 517. If the system predicts that the goals are going to be met, the system can continue according to plan and the campaign can be completed 517. More detailed explanations of the first, second and third algorithms are below.

The system can utilize a first algorithm which can use a neural network(s) to automatically customize templates to maximize the likelihood of campaign success. The inventive system deploys a neural network model to predict the probability of campaign success. The model consists of a weighted summation of inputs, a transfer function, and an output. The inputs can be divided into two categories: fixed inputs and lever inputs. Fixed inputs are entered by a user at the start of their campaign, and may include: category, goal, duration, and number of social media accounts. “Lever” inputs are parameters over which we have control, and may include: the intent of a post, its destination social media platform and its scheduling time.

The predicts campaign success based on fixed inputs using historical data and creates a table of predictions for various values of the lever variable.

### Inputs:

### Fixed Inputs

### Category: Arts/Entertainment

### Campaign Goal: $8,000

### Duration: 45 Days

### Social Media Accounts: 3 Twitter, 2 Facebook, 1 Instagram

Lever input: Number of social media posts

| | | | | | | | | |
|---|---|---|---|---|---|---|---|---|
| Lever input: | 100 | 110 | 120 | 130 | 140 | 150 | 160 | 170 |
| Number of posts (P) | | | | | | | | |
| Output: | .65 | .67 | .68 | .70 | .75 | .80 | .67 | .60 |
| Probability of | | | | | | | | |
| Campaign Success (S) | | | | | | | | |

The algorithm can select the value of P number of posts which optimizes the value of S. In this example, the system would select a template with 150 social media posts, which gives the campaign the highest chance of success at 80%.

The system can utilize a second algorithm which can use a neural networks to predict a funding model mid-campaign. As the SMC progresses, the system can receive additional inputs as they become available, such as levels of engagement and funding KPIs. The model will use three time series as inputs:
1. Time series of funding data (t=0 to current day)
2. Time series of engagement (t=0 to current day)
3. Time series of text of actual social media posts (t=0 through end of campaign)

These three inputs, along with existing the fixed inputs, can be fed into the neural networks model and transformed into an output that predicts the daily funding data for the remainder of the campaign. If at this mid-campaign point, the model is predicting SMC success and as a result of this check, no change to the SMC templates is made. However, if the neural networks model predicts the campaign will fail the template may be changed to help ensure success, using the first algorithm.

The system can utilize a third algorithm which can use hidden Markov Models to predict the next 7 posts. In situations where the system predicts that a campaign will fall short of its goal, the system can adjust the SMC templates. For instance, if on day 15 of a 30-day campaign, the neural networks model estimates it will make only $13,000 of its $15,000 KPI goal, the system knows that additional funding is needed to make up the current $2,000 short-fall.

One way to make up for this $2,000 gap is to create events to stimulate funding spikes. To do so, the system can automatically change the remainder of the posts in the template to create sequences that optimize the likelihood of a funding spike. Statistical modeling has shown that certain patterns of social media postings can correlate to spikes in funding. Although these patterns in the templates at t=0, the system can add more of these social media postings pattern sequences mid-campaign to hopefully increase funding.

Using Hidden Markov Chains, the system model can generate sequences of social media posts that will optimize the chances of a spike in funding. Below are examples of seven sequences of postings changes certain intents that are correlated with a funding spike. In the examples below, the numbers correspond to social media post intents where 1=Establish Identity, 2=Build Community, 3=Outreach and 4=Sell.
1. Switching intent from “Sell” to “Community Building”: [4, 4, 4, 4, 4, 4, 2]
2. Switching from “Community Building” to “Outreach”: [2, 2, 2, 2, 2, 2, 3]
3. Switching from “Community Building” to “Establish Identity”: [2, 2, 2, 2, 2, 2, 1]

The templates can automatically adjust on day 15 to include several of these patterns in the next five days. The system instructs the user to create this new content under these intent labels if needed, or will adjust the existing content that the user already entered. Once the content is updated, that information is fed back into the neural networks algorithm, and the predicted total amount raised is updated. If the model predicts the user will only make $14,000 after making these changes, the system will send a notification to the user to take additional actions like paying for boosted Facebook posts to target audiences, or to add new campaign prizes for a limited time.

### Definitions of Terms

### Social Media Campaign (“SMC”)

An SMC is the use of social media networks, such as Facebook and Twitter, to achieve a specific, objective over a set period of time—for example, to launch a product or service, to encourage attendance at an event, or to raise general awareness of any entity. A SMC seeks to find the largest audience of people and then to offer them content that 1. creates engagement, 2. communicates the SMC story, and 3. calls the audience to action. An SMC consists of both carefully planned activity (story-telling and mechanics to maximize engagement) and ad-hoc response to audience engagement (which, by definition, cannot be planned). It can use all types of media that work for online consumption, primarily text and image (both still and moving).

### Generic Model of Social Media Campaign

A generic model of an SMC is an algorithmic description of the common ‘rules’ governing the success or failure of any SMC within a given business domain. In the terms of the product, it describes how social media activity relates to the KPI of a campaign within a given business domain, controlling for different environmental parameters and campaign variables. Table 2 below lists possible KPIs and KPI units associated with several example business domains.

TABLE 2

| Business | | |
|---|---|---|
| Domain | KPI | Units |
| Crowd Funding | Percentage of Funding Goal | % |
| | Sum Raised | $ |
| Performance | Tickets Sold | Number of pre-sales tickets |
| Retail | Units Sold | Pre-products sold |
| Real Estate | Time to Escrow | Days |
| Book Launch | Pre-Sales prior to | Number of pre-sale books |
| | publication | |

The invention system uses a social media strategy as a tool to affect a business KPI goal. Different types of KPI (goals), such as “time taken” or “count, units sold” or “sum, money raised” require different types of social media to affect the KPI for the SMC or achieve the KM SMC goal. The SMC strategy can include specific releases and timing of social media postings. The SMC campaign can including but is not limited to the intent of the social media posts and the frequency of the social media posting.

For example, where the KPI for a SMC is “time taken” with units in time units, a social media campaign may have more a higher concentration of posts designed to create a sense of urgency, and to directly solicit contributions. In contrast, where the KPI is “sum, money raised,” a greater concentration of social media posts can have the intent of awareness of the need to raise money which may be seen early in the campaign, with a sense of urgency being built toward the end of the campaign. For each domain, the ‘generic model’ can predict what type of social media campaign is most likely to achieve the desired KPI when interrogated with certain variables and parameters, outputting customized strategy and tactics.

### Social Campaign Anatomy (“SCA”)

A ‘Social Campaign Anatomy,’ or “SCA,” is a way of preserving an entire SCM. It is a database holding all content, data and metadata, both quantitative and qualitative, for a specific, real-world, social media campaign (“SMC”). An SCA is bounded by the start and end dates of a campaign. The content it stores includes every single message posted by the campaigner on any social media account used for campaigning—this includes any text (including URLs) and any binary file such as image or video. The quantitative metadata it stores includes everything generated by the social media platform used to publish a message, such as views, plays, ‘shares’ or comments. Quantitative metadata is also stored for the associated KPI for a given campaign: in the case of a crowd funding campaign this includes the financial contributions and the number and name of all contributors across time. The qualitative metadata in an SCA comprises descriptive, semantic analysis for every message, such as the intent of the campaigner for the effect of every message (for example, “To raise awareness”).

### Abstract Business Goal

An “abstract business goal” is any specific goal with a KPI that can be affected by an SMC. For example, “Launch a new headphone on July 12,” “Raise $30,000 by August 14,” “Sell 4,000 tickets for a concert on September 5.”

### Customized Strategy and Tactics

“Customized strategy and tactics” mean strategy and tactics derived from a generic model of an SMC for a given business domain, customized for a specific user's circumstances. This is achieved by entering specific variables and parameters into the generic model, and running the algorithm with these variables to output optimal data; this data is made usable for a non-expert by rendering it in the form of (for example) a template for an entire social media campaign. For example, a user running a crowd funding campaign for a documentary film may enter a target raise of $12,000 by December 31. The algorithm suggests a 30-day campaign of posts with specific quantitative and qualitative parameters. This is presented to the user as a template for a crowd funding SMC consisting of the optimal number of pre-written posts, complete with scheduling information, text and even graphics and video that communicate to the user how they should best go about creating graphics and video that will have the same qualitative ‘value’ as the template posts.

### Taxonomy of Intent

A “Taxonomy of Intent”—every single message posted on a social media campaign was done so with intent, even if that intent was ‘just social’. A Taxonomy of Intent is exactly what it sounds like: a hierarchical list of the different types of intent a social media campaigner can employ for their messages in a social media campaign—literally, what they intend their messages to achieve. For example, “seek validation” or “build community.” A Taxonomy of Intent is one device for permitting the inclusion of semantic data in an SCA, so the effect of qualitative differences between social media messages on a business KPI may be ascertained. A Taxonomy of Intent is used as part of a programmatic system that permits programmatic attribution of intent to a post, and which minimizes subjectivity in the process. Different business domains have different Taxonomies of Intent.

### Key Performance Indicator

A key performance indicator (“KPI”) is a measurement which an entity deems fundamental to understanding its overall performance over time (health, growth, or conformance with strategy).

### Social Media Engagement Data

Social media engagement data is data that quantifies public engagement with content published on social media. For example, once published, social media audiences can (in generally accepted order of importance) typically “like” a piece of content, comment on it or share it themselves. Measuring this quantitative data, and understanding the significance of the ratios of the different types of content to each other, can assist a social media publisher understand the way an audience perceives them, and the content they publish.

### The Process Performed by the Invention

User supplies data→customized strategy and tactics generated→rendered in human-readable form.
1. The user supplies the system information about their campaign. They can do this manually, datapoint by datapoint, or they can enter the URL of a server containing this information (in the initial embodiment, the URL of their crowd funding campaign on a platform such as Kickstarter). This data may, among other data points, include: 1. the category of campaign (e.g. documentary crowd funding campaign, ticket sales for a new theatrical performance etc.), 2. the KPI and goal (e.g. $30,000 raised or 5,000 tickets), 3. the start and end date of the campaign, 4. images, video and text related to the campaign. The system also seeks some information about the campaign from 3rd party servers. For example, it checks to see how many followers the user has on Twitter, and searches various internet servers to find out how ‘hot’ a topic their campaign is. This information is fed into the model. The system calculates customized strategy and tactics (described above), which typically includes what posts are most likely to achieve the user's goal: the number of posts, the social media platforms, the best time of day and the most appropriate intent of each post.

To make this usable, the system visualizes this information to the user in the form of a template campaign: every post, scheduled for the appropriate time and place. The template even contains text and image content, which demonstrates to the user how they should create their own content to achieve a specific intent. For example, if the user is making a documentary, the system shows them a campaign for a generic documentary which has the exact same parameters (goal, start date, end date and so on); where a post should have the intent of “introducing the team,” the template content contains a stylized image of a campaign team and words about introducing a team.

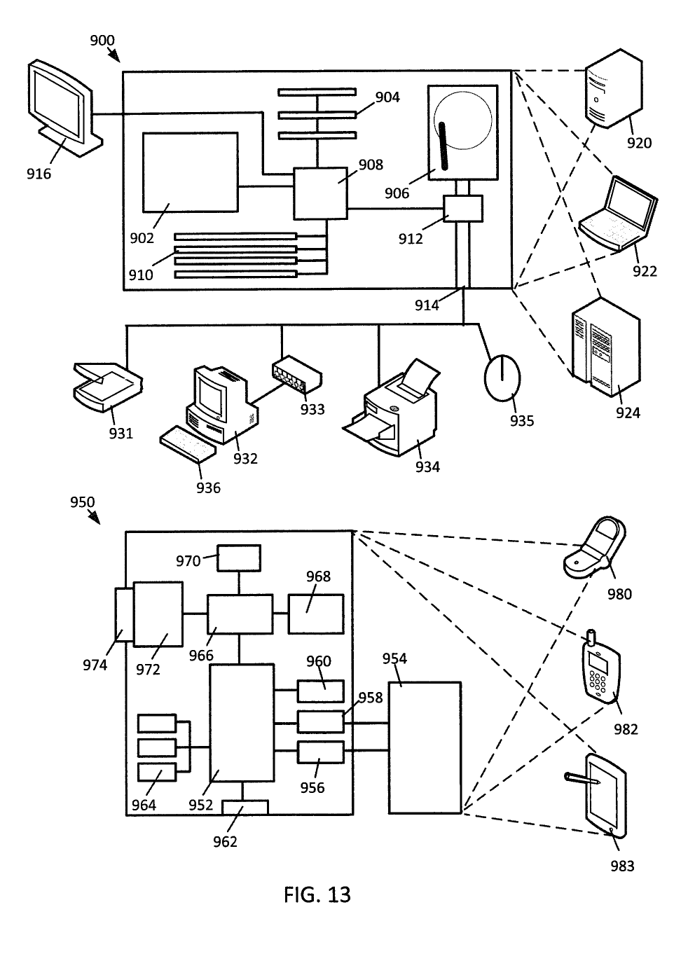

FIG. 13 shows an example of a generic computer device 900 and a generic mobile computer device 950, which may be used to implement the processes described herein, including the mobile-side and server-side processes for installing a computer program from a mobile device to a computer. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components processor 902, memory 904, storage device 906, high-speed interface 908, high-speed expansion ports 910, and low speed interface 912 are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple busses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port 914, which may include various communication ports (e.g., USB, Bluetooth, Ethernet, wireless Ethernet), may be coupled to one or more input/output devices, such as a keyboard 936 in communication with a computer 932, a pointing device 935, a scanner 931, or a networking device 933 such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a Microdrive, solid state memory or other device, to provide additional storage. Each of the components computing device 950, processor 952, memory 964, display 954, communication interface 966, and transceiver 968 are interconnected using various busses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, memory on processor 952, or a propagated signal that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, a tablet computer 983 or other similar mobile computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The present disclosure has been described with reference to various embodiments. However, one of ordinary skill in the art appreciates that various modifications and changes can be made without departing from the scope of this disclosure. The specification is to be regarded in an illustrative rather than a restrictive sense, and all such modifications are intended to be included within the scope of the present disclosure. Likewise, benefits, solutions, and other advantages to problems or issues have been described above with regard to various embodiments. However these described benefits are not to be construed as critical, essential, or necessary features or elements.

What is claimed is:

1. A social media campaign method comprising:
providing a server in communication with a client computing device through a network;
transmitting by the client computer fixed inputs that include two or more of: a start date, a campaign duration, a target fund raise, key performance indicator goals and a product category to the server;
creating by the server a first social media campaign plan using a first algorithm based upon the product category, the campaign template includes a schedule for the social media posts that includes text and videos, wherein each of the social media posts has one of a plurality of intents;
transmitting the first social media campaign plan by the server to the client computing device;
displaying the social media campaign on the client computing device;
monitoring a key performance indicator by the server; and
continuously predicting a likelihood of reaching a campaign goal by the server.

2. The social media campaign method of claim 1 further comprising:
transmitting additional inputs to the server;
creating adjustments to the social media campaign by the server using a second algorithm based upon the differences between the key performance indicator and a key performance indicator goal; and
transmitting the adjustments to the social media campaign by the server to the client computing device; and
displaying the adjustments to the social media campaign on the client computing device.

3. The social media campaign method of claim 1 further comprising:
determining by the server, that the actual key performance indicators are below the key performance indicator goals;
creating adjustments to the social media campaign by the server using a second algorithm based upon the differences between actual key performance indicators and the key performance indicator goals; and
transmitting the adjustments to the social media campaign by the server to the client computing device; and
displaying the adjustments to the social media campaign on the client computing device.

4. The social media campaign method of claim 1 further comprising:
creating by the server, a graph representing the key performance indicator goals and the actual key performance indicators over time;
transmitting the graph from the server to the client computing device; and
displaying the graph on the client computing device.

5. The social media campaign method of claim 1 further comprising:
dividing the social media campaign into a plurality of phases over time by the server, wherein the plurality of phases include at least two of: a tease, a launch, a push, a count down and a final sprint;
transmitting the plurality of phases from the server to the client computing device; and
displaying the plurality of phases on the client computing device.

6. The social media campaign method of claim 1 wherein the key performance indicator is a measure of: health, growth or conformance.

7. The social media campaign method of claim 1 wherein the intent of each of the social media posts includes at least one of: campaign identity, community building, outreach or selling.

8. A social media campaign method comprising:
providing a server in communication with a client computing device through a network;
transmitting by the client computer fixed inputs that include two or more of: a start date, a campaign duration, a target fund raise, key performance indicator goals and a product category to the server;
creating by the server a first social media campaign plan using a first algorithm based upon the product category, the campaign template includes a schedule for the social media posts that includes text and videos, wherein each of the social media posts has one of a plurality of intents and the first social media campaign plan a number of posts;
transmitting the first social media campaign plan by the server to the client computing device;
displaying the social media campaign plan on the client computing device;
monitoring social media posts by the server for compliance with the social media campaign plan; and
continuously predicting a likelihood of reaching a campaign goal by the server.

9. The social media campaign method of claim 8 further comprising:
transmitting additional inputs to the server;
creating adjustments to the social media campaign by the server using a second algorithm based upon a differences between actual key performance indicator and a key performance indicator goal; and
transmitting the adjustments to the social media campaign by the server to the client computing device; and
displaying the adjustments to the social media campaign on the client computing device.

10. The social media campaign method of claim 8 further comprising:
determining by the server, that the key performance indicator is below the key performance indicator goal;
creating adjustments to the social media campaign by the server using a second algorithm based upon the differences between actual key performance indicators and the key performance indicator goals; and
transmitting the adjustments to the social media campaign by the server to the client computing device; and
displaying the adjustments to the social media campaign on the client computing device.

11. The social media campaign method of claim 8 further comprising:
creating by the server, a graph representing the key performance indicator goals and the actual key performance indicators over time;
transmitting the graph from the server to the client computing device; and
displaying the graph on the client computing device.

12. The social media campaign method of claim 8 further comprising:
dividing the social media campaign into a plurality of phases over time by the server, wherein the plurality of phases include at least two of: a tease, a launch, a push, a count down and a final sprint;
transmitting the plurality of phases from the server to the client computing device; and
displaying the plurality of phases on the client computing device.

13. The social media campaign method of claim 8 wherein the key performance indicator is a measure of: health, growth or conformance.

14. The social media campaign method of claim 8 wherein the intent of each of the social media posts includes at least one of: campaign identity, community building, outreach or selling.

15. A social media campaign method comprising:
providing a server in communication with a client computing device through a network;
transmitting by the client computer fixed inputs that include: a start date, a campaign duration, a target fund raise, a key performance indicator goal, and a product category to the server;
obtaining by the server, a social media campaign template that matches the product category from a template database;
creating by the server, a first social media campaign by applying the start date, the campaign duration, the target fund raise, and the key performance indicator goal to the social media campaign template wherein the social media campaign includes a schedule for the social media posts that includes text and videos and each of the social media posts has one of a plurality of intent classifications;
transmitting the first social media campaign by the server to the client computing device;
posting by the client computing device, the social media posts in accordance with the first social media campaign;
monitoring by the server, key performance indicators;
predicting by the server, a likelihood of reaching a campaign goal based upon the key performance indicators; and
transmitting the likelihood of reaching the campaign goal from the server to the client computing device.

16. The social media campaign method of claim 15 further comprising:
determining by the server, that the likelihood of reaching the campaign goal is less than a predetermined value; and
creating by the server, a second social media campaign based upon the key performance indicators monitored by the server;
transmitting the second social media campaign by the server to the client computing device; and
posting by the client computing device, the social media posts in accordance with the second social media campaign.

17. The social media campaign method of claim 15 further comprising:
determining by the server, that the likelihood of reaching the campaign goal is more than a predetermined value;
calculating adjustments to the first social media campaign by the server to reduce a quantity of the social posts from the first social media campaign; and
transmitting the adjustments to the first social media campaign from the server to the client computing device.
